(19) United States
(12) Patent Application Publication
(10) Pub. No.: US 2007/0156578 A1
(43) Pub. Date: Jul. 5, 2007

(54) METHOD AND SYSTEM FOR REDUCING A NUMBER OF FINANCIAL TRANSACTIONS

(75) Inventor: Marcelo Perazolo, Cary, NC (US)

Correspondence Address: MOORE & VAN ALLEN, PLLC For IBM, P.O. Box 13706, Research Triangle Park, NC, 27709, US

(73) Assignee: International Business Machines Corporation, Armonk, NY (US)

(21) Appl. No.: 11/306,569

(22) Filed: Jan. 3, 2006

(51) Int. Cl. G06Q 40/00

(52) U.S. Cl. 705/39

(57) ABSTRACT

A method for reducing the number of transactions may include determining a net value of at least one return-exchange transaction. The method may also include sending a single transaction to a payment provider based on one of a positive and a negative net value.

### BACKGROUND OF THE INVENTION

The present invention relates to commercial transactions, e-commerce and the like, and more particularly to a method and system for reducing the number of financial transactions in a return-exchange transaction process.

A return-exchange transaction may involve a customer returning purchased items or goods to a merchant and ordering other items or goods. Money or funds will change hands in both directions, from the merchant to the customer for the returned goods and from the customer to the merchant for the new order. Thus, multiple financial transactions are created by the merchant in both directions to provide specific records of how money is transferred with respect to each of the orders and returns. The returns and new orders while associated are logically detached for purposes of accountability and traceability. The multiple detached transactions results in additional communications with a payment provider, such as a credit card company, bank or other financial institution, to perform each transaction. Additionally, the merchant is typically charged a fee for each of these transactions.

### BRIEF SUMMARY OF THE INVENTION

In accordance with an embodiment of the present invention, a method for reducing a number of transactions may include determining a net value of at least one return-exchange transaction. The method may also include sending a single transaction to a payment provider based on the net value being one of a positive and a negative net value.

In accordance with another embodiment of the present invention, a system for reducing a number of financial transactions may include a detector to detect a return-exchange transaction. The system may also include a net value computation module to determine a net value of the return-exchange transaction.

In accordance with another embodiment of the present invention, a computer program product for reducing a number of financial transactions may include a computer usable medium having computer usable program code embodied therein. The computer usable medium may include computer usable program code configured to determine a net value of at least one return-exchange transaction. The computer usable medium may also include computer usable program code configured to send a single transaction to a payment provider based on the net value being one of a positive and a negative net value.

Other aspects and features of the present invention, as defined solely by the claims, will become apparent to those ordinarily skilled in the art upon review of the following non-limited detailed description of the invention in conjunction with the accompanying figures.

### BRIEF DESCRIPTION OF THE SEVERAL VIEWS OF THE DRAWINGS

FIG. 1 is an exemplary system for reducing a number of financial transactions in accordance with an embodiment of the present invention.

FIGS. 2A and 2B (collectively FIG. 2) are a flow chart of an example of a method for reducing a number of financial transactions in accordance with an embodiment of the present invention.

FIG. 3 is a flow chart of an example of a method to determine a net value in a return-exchange transaction in accordance with an embodiment of the present invention.

### DETAILED DESCRIPTION OF THE INVENTION

The following detailed description of embodiments refers to the accompanying drawings, which illustrate specific embodiments of the invention. Other embodiments having different structures and operations do not depart from the scope of the present invention.

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

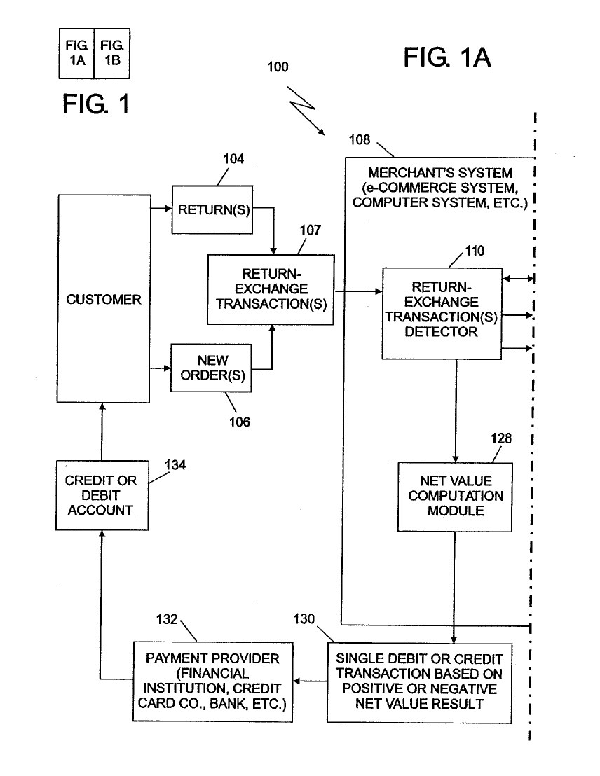

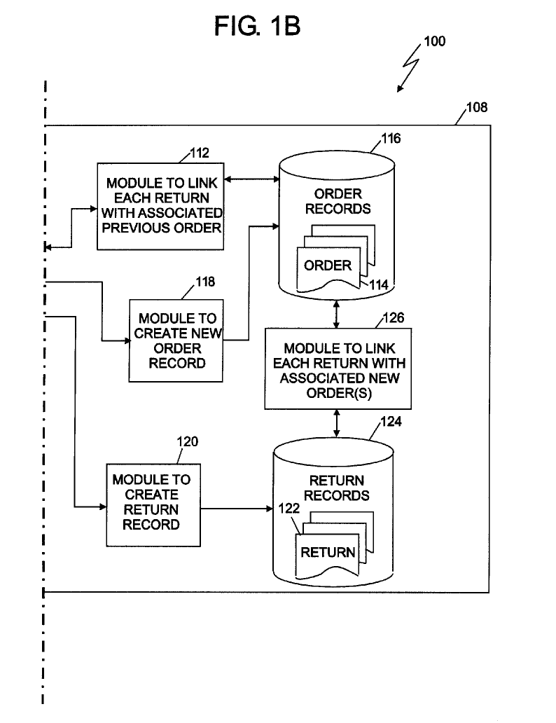

FIG. 1 is an exemplary system 100 for reducing a number of financial transactions in accordance with an embodiment of the present invention. A customer 102 may initiate a return 104 or returns by sending or returning one or more items or goods purchased in a previous order to a merchant. At the same time or in the same communication, the customer 102 may initiate a new order 106 or orders. The return 104 may be in exchange for items or goods identified in the new order 106 or orders. The return 104 and the new order 106 or a group of returns 104 and new orders may define a return-exchange transaction 107 or group of transactions.

A merchant's system 108 may include a return-exchange transaction detector 110 that may detect that the return 104 and new order 106 are related. For example, the detector 108 may detect that the return 104 and new order 106 are from the same customer, the return and new order are in the same communication or some other indication that the return 104 or returns and new order 106 or orders may be linked in a single return-exchange transaction 107 or reduced number of transactions. The return-exchange detector 110 may be function or feature on the merchant's order processing system, e-commerce system or the like that may detect or read information entered online by the customer 102 or in other communications, electronic or otherwise, from the customer 102.

The merchant's system 108 may also include a module 112 to link each return 104 with an associated previous order 114. The module 112 may access an order records database 116 containing records of previous orders to link each return 104 to an associated previous order 114.

A module 118 may be provided to create a new order record in response to each new order 106. Each new order may also be stored in the order records database 116 as an order 114. The merchant's system 108 may also include a module 120 to create a return record 122. The return record 122 may be stored in a return record database 124.

The merchant's system 108 may further include a module 126 to link each return 122 with an associated new order 114. The modules 112, 118 and 120, and 126 and any records generate thereby provide traceability and accountability for each transaction.

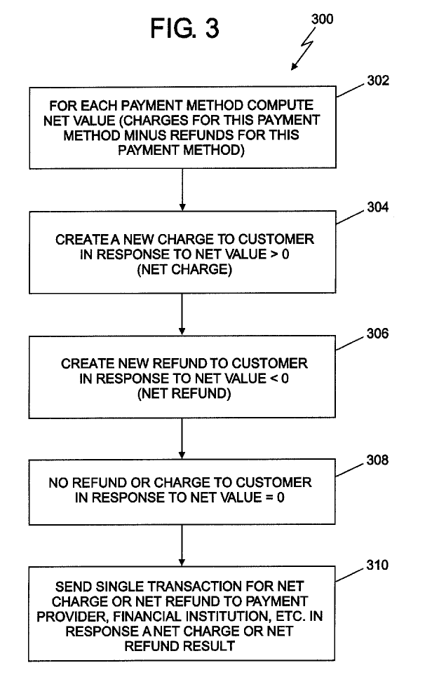

A net value computation module 128 may be provided to determine a net value of each return-exchange transaction 107. As will be described in more detail with reference to FIG. 3, the net value computation module 128 may determine if the transaction results in a net charge to the customer 102 or a net refund to the customer 102. A single debit or credit transaction 130 based on a positive or negative net value result from module 128 may then be sent to the payment provider 132. As previously discussed, the payment provider 132 may be a financial institution, credit card company, bank or the like. The payment provider 132 may then debit or credit the customer's account 134 based on the net value of the return-exchange transaction 107.

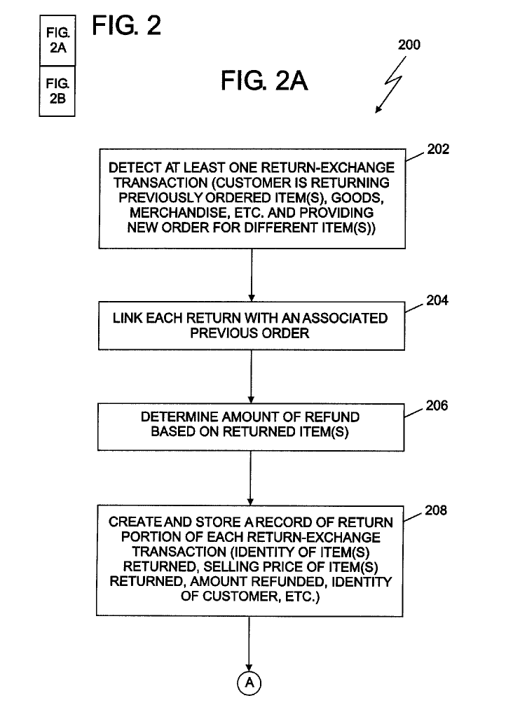

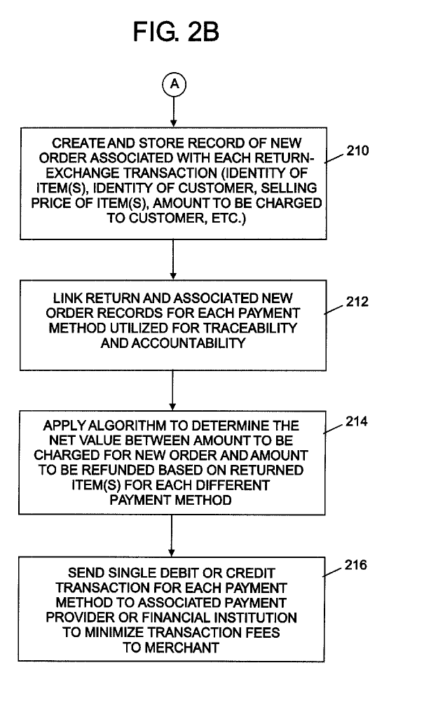

FIGS. 2A and 2B (collectively FIG. 2) are a flow chart of an example of a method 200 for reducing a number of financial transactions in accordance with an embodiment of the present invention. The method 200 may be embodied in the system 100 of FIG. 1. In block 202, at least one return-exchange transaction may be detected. Each return-exchange transaction may include a customer returning a previously ordered item or items, goods, merchandise or the like and providing a new order for other items or merchandise.

In block 204, each return may be linked with an associated previous order. In block 206, an amount of a refund based on the returned item or items may be determined. In block 208, a record of the return portion of each return-exchange transaction may be created and stored. The record may include an identity of the item or items returned, the selling price of the item or items returned, an amount to be refunded to the customer, an identity of the customer and any other information that may be appropriate to record the return portion of the transaction for traceability and accountability purposes.

In block 210, a record of each new order associated with each return-exchange transaction may be created and stored. The record may include an identity of item or items ordered, an identity of the customer, selling price of the item or items, amount to be charged the customer and any other information that may be important to record the new order portion of the transaction for traceability and accountability purposes.

In block 212, each return may be linked to an associated new order record for each payment method utilized for traceability and accountability.

In block 214, a algorithm to determine the net value between an amount to be charged for each new order and the amount to be refunded for an associated return may be applied for each different payment method. An example of a method 300 to determine the net value of a return-exchange transaction will be described with reference to FIG. 3.

In block 216, a single debt or credit transaction for each payment method may be sent to a payment provider associated with the return-exchange transaction to minimize communications between the merchant and the payment provider and to minimize resulting transactions fees to be paid by the merchant to the payment provider.

FIG. 3 is a flow chart of an example of a method 300 to determine a net value in a return-exchange transaction in accordance with an embodiment of the present invention. The method 300 may be used for the algorithm to determine the net value in block 214 of the method 200 (FIG. 2). In block 302, a net value may be computed or determined for each payment method. The net value may be charges for the new order under the particular payment method minus an amount to be refunded for any returns under the payment method.

In block 304, a new charge to the customer may be created in response to the net value being greater than zero. This would represent a net charge to the customer. In block 306, a new refund to the customer may be created in response to the net value being less than zero. This would represent a net refund to the customer. In block 308, no refund or charge to the customer would result in response to the net value being equal to zero.

In block 310, a single transaction for a net charge or a net refund may be sent to the payment provider, financial institution, credit card company or the like in response to whether a net charge or a net refund resulted from the net value determination.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A method for reducing a number of financial transactions, comprising:
determining a net value of at least one return-exchange transaction; and
sending a single transaction to a payment provider based on the net value being one of a positive and a negative net value.

2. The method of claim 1, further comprising detecting the at least one return-exchange transaction.

3. The method of claim 1, further comprising linking each return with an associated previous order.

4. The method of claim 1, further comprising determining an amount of a refund based on a value of at least one item being returned for exchange.

5. The method of claim 1, further comprising:
creating a return record of a return portion of each return-exchange transaction; and
storing each return record.

6. The method of claim 1, further comprising:
creating a new order record of a new order associated with each return-exchange transaction; and
storing each new order record.

7. The method of claim 1, further comprising linking each return record and each associated new order record.

8. The method of claim 1, further comprising determining the net value between an amount to be charged for a new order associated with each return-exchange transaction and an amount to be refunded based on at least one returned item.

9. The method of claim 1, further comprising applying a net value computation module to each return-exchange transaction to determine a net value between an amount to be charged for a new order associated with each return-exchange transaction and an amount to be refunded based on at least one returned item.

10. The method of claim 9, further comprising:
creating a net charge in response to the net value being greater than zero;
creating a net refund in response to the net value being less than zero; and
sending one of the net charge and the net refund to the payment provider.

11. A system for reducing a number of financial transactions, comprising:
a detector to detect a return-exchange transaction; and
a net value computation module to determine a net value of the return-exchange transaction.

12. The system of claim 11, further comprising a module to link each return with an associated previous order.

13. The system of claim 11, further comprising:
a module to create a return record of a return portion of the return-exchange transaction;
a module to create a new order record of a new order associated with the return-exchange transaction; and
a database to store the return record and the new order record.

14. The system of claim 13, further comprising a module to link the return record and the new order record to provide traceability and accountability.

15. A computer program product for reducing the number of financial transactions, the computer program product comprising:
a computer usable medium having computer usable program code embodied therein, the computer usable medium comprising:
computer usable program code configured to determine a net value of at least one return-exchange transaction; and
computer usable program code configured to send a single transaction to a payment provider based on the net value being one of a positive and a negative net value.

16. The computer program product of claim 15, further comprising:
computer usable program code configured to create a return record of a return portion of each return-exchange transaction; and
computer usable program code configured to create a new order record of a new order associated with each return-exchange transaction.

17. The computer program product of claim 16, further comprising computer usable program code configured to link each return record and each associated new order record.

18. The computer program product of claim 15, further comprising computer usable program code configured to determine the net value between an amount to be charged for a new order associated with each return-exchange transaction and an amount to be refunded based on at least one returned item.

19. The computer program product of claim 15, further comprising computer usable program code configured to create one of a net charge in response to the net value being greater than zero and a net refund in response to the net value being less than zero.

20. The computer program product of claim 19, further comprising computer usable program code configured to send one of the net charge and the net refund to the payment provider.
